(19) United States
(12) Patent Application Publication
(10) Pub. No.: US 2026/0362537 A1
(43) Pub. Date: Nov. 12, 2026

(54) TEMPORARY CAMPING ON A CELL

(71) Applicant: QUALCOMM Incorporated, San Diego, CA (US)

(72) Inventors: Navid ABEDINI, Basking Ridge, NJ (US); Tao LUO, San Diego, CA (US); Junyi LI, Greentown, PA (US)

(21) Appl. No.: 19/203,085

(22) Filed: May 8, 2025

(51) Int. Cl. H04W 76/27; H04W 74/0833; H04W 76/40

(52) U.S. Cl. CPC H04W 76/27; H04W 74/0833; H04W 76/40

(57) ABSTRACT

This disclosure provides methods, components, devices and systems for temporary camping on a cell. A user equipment (UE) may temporarily camp on a cell or a set of multiple cells after transitioning from a radio resource control (RRC) connected state with the cell(s) to the RRC idle or inactive state with the cell(s) where the cell(s) implement network energy saving (NES) techniques. The temporary period may be defined by a timer at the UE and/or the temporary period may end when the cell sends a control message that indicates the end of the temporary period. At the end of the temporary period, the UE may perform cell reselection to transition to either an RRC connected mode or state or an RRC idle or inactive mode or state (e.g., to camp on) with another cell (or another set of multiple cells).

### TECHNICAL FIELD

This disclosure relates generally to wireless communication, and more specifically to systems, devices, methods, and techniques associated with temporary camping on a cell.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a user equipment (UE) is described. The method may include obtaining, at a first time instance, control information that indicates to transition from a radio resource control (RRC) connected state with a set of cells to an RRC idle or inactive state associated with camping on a first cell of the set of cells, obtaining, at a second time instance while in the RRC idle or inactive state, an indication to terminate camping on the first cell based on satisfaction of a threshold duration after the first time instance or receipt of a control message from the first cell, and performing, based on the indication to terminate camping on the first cell, a cell reselection procedure with a second cell.

A UE for wireless communications is described. The UE may include a processing system that includes processor circuitry and memory circuitry that stores code. The processing system may be configured to cause the UE to obtain, at a first time instance, control information that indicates to transition from an RRC connected state with a set of cells to an RRC idle or inactive state associated with camping on a first cell of the set of cells, obtain, at a second time instance while in the RRC idle or inactive state, an indication to terminate camping on the first cell based on satisfaction of a threshold duration after the first time instance or receipt of a control message from the first cell, and perform, based on the indication to terminate camping on the first cell, a cell reselection procedure with a second cell.

Another UE for wireless communications is described. The UE may include means for obtaining, at a first time instance, control information that indicates to transition from an RRC connected state with a set of cells to an RRC idle or inactive state associated with camping on a first cell of the set of cells, means for obtaining, at a second time instance while in the RRC idle or inactive state, an indication to terminate camping on the first cell based on satisfaction of a threshold duration after the first time instance or receipt of a control message from the first cell, and means for performing, based on the indication to terminate camping on the first cell, a cell reselection procedure with a second cell.

A non-transitory computer-readable medium storing code for wireless communications is described. The code may include instructions executable by one or more processors to obtain, at a first time instance, control information that indicates to transition from an RRC connected state with a set of cells to an RRC idle or inactive state associated with camping on a first cell of the set of cells, obtain, at a second time instance while in the RRC idle or inactive state, an indication to terminate camping on the first cell based on satisfaction of a threshold duration after the first time instance or receipt of a control message from the first cell, and perform, based on the indication to terminate camping on the first cell, a cell reselection procedure with a second cell.

In some examples of the method, UEs, and non-transitory computer-readable medium described herein, the control information further indicates the threshold duration.

Some examples of the method, UEs, and non-transitory computer-readable medium described herein may further include operations, features, means, or instructions for obtaining, from the first cell after the first time instance and before the second time instance, a second control message that resets or extends the threshold duration.

Some examples of the method, UEs, and non-transitory computer-readable medium described herein may further include operations, features, means, or instructions for obtaining second control information that indicates the first cell may be operating in accordance with an energy saving configuration, where obtaining the indication to terminate camping on the first cell may be based on the second control information.

Some examples of the method, UEs, and non-transitory computer-readable medium described herein may further include operations, features, means, or instructions for outputting, after the first time instance and before the second time instance, a second control message that resets or extends the threshold duration or indicates that the UE will terminate camping on the first cell.

In some examples of the method, UEs, and non-transitory computer-readable medium described herein, performing the cell reselection procedure may include operations, features, means, or instructions for performing the cell reselection procedure in accordance with a first cell reselection configuration associated with camping on a cell associated with a first frequency range that may be different from a second cell reselection configuration associated with camping on a cell of a second frequency range, where the second frequency range may be lower than the first frequency range.

Some examples of the method, UEs, and non-transitory computer-readable medium described herein may further include operations, features, means, or instructions for monitoring for, from the first cell after the first time instance and prior to the second time instance, paging messages, system information, synchronization signal blocks, or a combination thereof.

Some examples of the method, UEs, and non-transitory computer-readable medium described herein may further include operations, features, means, or instructions for obtaining an indication of a signaling configuration associated with camping on the first cell, where the monitoring may be based on the signaling configuration.

Some examples of the method, UEs, and non-transitory computer-readable medium described herein may further include operations, features, means, or instructions for obtaining second control information that indicates one or more parameters associated with the cell reselection procedure, where the one or more parameters include a list of candidate cells, priorities associated with candidate cells, channel quality threshold information, or a combination thereof.

Some examples of the method, UEs, and non-transitory computer-readable medium described herein may further include operations, features, means, or instructions for outputting, for the first cell, an acknowledgment message in response to the control message.

Some examples of the method, UEs, and non-transitory computer-readable medium described herein may further include operations, features, means, or instructions for outputting, to the second cell, an indication of selection of the second cell in accordance with the cell reselection procedure.

Some examples of the method, UEs, and non-transitory computer-readable medium described herein may further include operations, features, means, or instructions for performing the cell reselection procedure may be based on an absence of a control signal from the first cell during the threshold duration, the control signal associated with resetting the threshold duration.

### BRIEF DESCRIPTION OF THE DRAWINGS

FIG. 1 shows an example of a wireless communication system.

FIG. 2 shows an example of a signaling configuration that supports temporary camping on a cell.

FIG. 3 shows an example of a process flow that supports temporary camping on a cell.

FIG. 4 shows a block diagram of a processing system that supports temporary camping on a cell.

FIG. 5 shows a diagram of a system including a device that supports temporary camping on a cell.

FIGS. 6 through 8 show flowcharts illustrating methods that support temporary camping on a cell.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a user equipment (UE) may transition from a radio resource control (RRC) connected state to an RRC idle or inactive state with a serving cell (or with multiple serving cells) to save energy when the UE does not have data to communicate with the serving cell(s) or when the serving cell(s) do not have data to communicate with the UE. In an RRC idle or inactive state, the UE may camp on the cell. A UE that camps on a cell may refer to a UE that monitors for paging messages from the cell in paging occasions and/or measures the serving cell on which the UE is camped and other neighbor/candidate cells for cell reselection. For example, while camped on a cell, the UE may remain associated with the cell and the UE may measure reference signals from the cell on which the UE is camped and other candidate/neighbor cells (e.g., may measure reference signals such as synchronization signal blocks (SSBs) transmitted by the other cells) to evaluate the cells for cell reselection. In some examples, the UE may camp on multiple cells (e.g., in carrier aggregation scenarios where the UE was in the RRC active state with multiple serving cells). The UE may wake from the RRC idle or inactive state (e.g., and transition back to the RRC connected state with the serving cell) based on reception of a paging message from the serving cell that identifies the UE (e.g., which may indicate the serving cell has data to transmit to the UE). In some examples, the UE may wake from the RRC idle or inactive state (e.g., and transition back to the RRC connected state with the serving cell) when the UE has uplink data to transmit to the serving cell. In some examples, to transition back to an RRC active state, the UE may transmit a message (e.g., a random access preamble) to the cell in a random access channel (RACH) occasion. Accordingly, serving cells may monitor RACH occasions (ROs) for messages from UEs. Available ROs (e.g., which resources a given cell may monitor for random access messages from UEs) may be configured by a cell (e.g., indicated to UEs) in SI or other control signaling (such as RRC signaling). In some examples, to transition back to an RRC active state, the UE may transmit a cell wake up signal (WUS) in a WUS monitoring occasion (e.g., where the cell may configure such WUS occasions for the UE).

Cells may include macro cells (which may provide coverage to a large physical area via use of a lower frequency range) and small cells (which may provide coverage to a smaller physical area and may use a higher frequency range). Small cells may be used to serve a UE in an RRC connected state. Some cells, such as small cells, may implement network energy saving (NES) techniques, which may involve reduced transmission of signals such as SSBs, paging messages, system information (SI), and/or reduced monitoring of ROs. SSBs, paging messages, SI, and ROs may be used by a UE for camping on a given serving cell. Accordingly, in some cases, a UE that is served on a cell in the RRC connected state may be unable to camp on the cell in an RRC idle or inactive state if the cell implements NES techniques.

Aspects of the subject matter described in this disclosure relate to temporary camping on a cell after transitioning from an RRC connected state with the cell to the RRC idle or inactive state with the cell where the cell implements NES techniques. For example, a cell that implements NES techniques may provide paging messages in paging occasions, may transmit SSBs, may transmit SI and/or may maintain the same SI as when the UE was in the RRC active state, may monitor ROs, and/or may monitor for cell WUSs for a temporary period after the UE enters the RRC idle or inactive state. Accordingly, the UE may temporarily camp on the cell after the UE enters the RRC idle or inactive state. At the end of the temporary period, the UE may perform cell reselection to transition to either an RRC connected mode or an RRC idle or inactive state (e.g., to camp on) with another cell (or another set of multiple cells). In some examples, the UE may temporarily camp on multiple cells (e.g., multiple small cells or multiple cells that implement NES techniques). In some examples, the temporary period may be defined by a timer at the UE (e.g., that starts when the UE enters the RRC idle or inactive mode or state). In some examples, the temporary period may end when the cell (or one or the cells on which the UE is camping) sends a control message that indicates the end of the temporary period (e.g., that indicates for the UE to perform cell reselection). In some examples, the cell(s) and/or the UE may send control message(s) that extend or reset the timer, enabling the UE to extend temporary camping on the cell(s).

Particular aspects of the subject matter described in this disclosure can be implemented to realize one or more of the following potential advantages. In some examples, by implementing techniques to define a temporary camping period, the described techniques can be used to enable a UE to be served by a cell in the RRC active state and then transition to camping on the cell where the cell implements NES techniques. For example, the cell may temporarily refrain from implementing NES techniques and/or may modify NES techniques while the UE is camped on the cell in order to enable the UE to camp on the cell. Accordingly, the UE may refrain from immediately performing cell reselection to another cell when transitioning from the RRC active state with the NES cell. Such techniques may further enable small cells (which may provide higher data rates and/or may be used to service UEs in high-traffic scenarios) to service UEs and implement NES techniques.

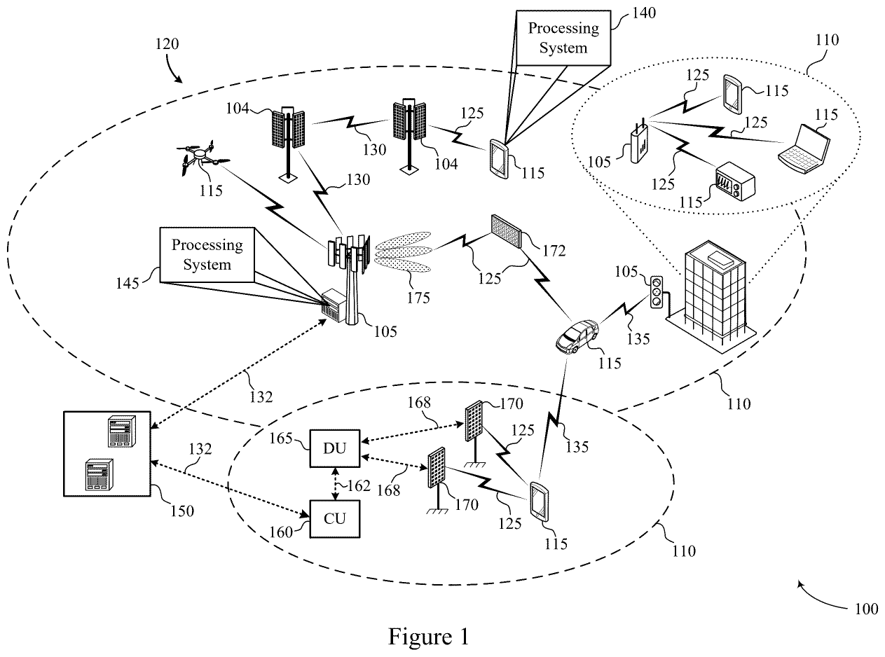

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Network entities 105 or UEs 115 may support concurrent communication using multiple carriers, which may be referred to as carrier aggregation, for which each of the multiple carriers may be referred to as a component carrier (CC). Carrier aggregation may be used with both FDD and TDD CCs. In some examples of carrier aggregation, a CC may have acquisition signaling or control signaling that coordinates operations for other CCs. A CC may be operated in a standalone mode, such that initial acquisition and connection may be conducted by the UEs 115 via the CC, or the CC may be operated in a non-standalone mode, such that a connection is anchored using a different CC (such as of the same or a different RAT).

Additionally, or alternatively, UEs 115 may support concurrent communication via multiple network entities 105 (such as multiple base stations, multiple RUs 170, multiple DUs 165, multiple CUs 160), which may be referred to as dual connectivity (DC). Such techniques may implement a master cell group (MCG), which may refer to one or more cells associated with a primary network entity 105 (such as a network entity 105 with which a UE 115 establishes a first communication link 125), and a secondary cell group (SCG), which may refer to one or more cells associated with a secondary network entity 105 (such as a network entity 105 with which the UE 115 establishes a second communication link 125). An MCG may include a special cell (SpCell), referred to as a primary cell (PCell), that supports initial access and configuration with the MCG, and an SCG also may include an SpCell, referred to as a primary secondary cell (PSCell), that supports initial access and configuration with the SCG. An MCG, an SCG, or both also may include one or more secondary cells (SCells) that support further access with the respective group, which may implement aspects of a carrier aggregation configuration via the respective network entity 105.

Devices of the wireless communication system 100 may be configured to support one or more aspects of the described techniques for temporary camping on a cell. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support temporary camping on a cell or a set of multiple cells after transitioning from an RRC connected state with the cell(s) to the RRC idle or inactive state with the cell(s) where the cell(s) implement NES techniques. A cell that implements NES techniques may provide paging messages in paging occasions, may transmit SSBs, may transmit SI, may monitor ROs, and/or may monitor for cell WUSs for a temporary period after the UE 115 enters an RRC idle or inactive state. The temporary period may be defined by a timer at the UE 115 and/or the temporary period may end when the cell sends a control message that indicates the end of the temporary period. At the end of the temporary period, the UE may perform cell reselection to transition to either an RRC connected state or an RRC idle or inactive state (e.g., to camp on) with another cell (or another set of multiple cells). Accordingly, the UE 115 may temporarily camp on the cell which implements NES techniques after the UE 115 enters the RRC idle or inactive mode.

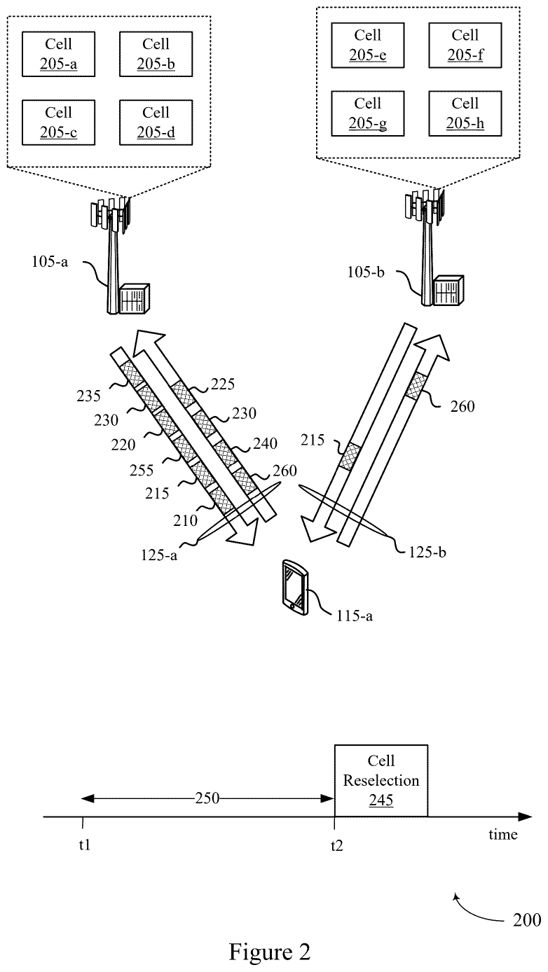

FIG. 2 shows an example of a signaling configuration 200 that supports temporary camping on a cell. The signaling configuration 200 may implement or may be implemented by aspects of the wireless communication system 100. For example, the signaling configuration 200 may include a UE 115-a, which may be an example of a UE 115 as described herein. The signaling configuration 200 may include a network entity 105-a and a network entity 105-b, which may be examples of network entities 105 as described herein.

The UE 115-a may communicate with the network entity 105-a using a communication link 125-a. The UE 115-a may communicate with the network entity 105-b using a communication link 125-b. The communication link 125-a may be an example of an NR or LTE link between the UE 115-a and the network entity 105-a. The communication link 125-b may be an example of an NR or LTE link between the UE 115-a and the network entity 105-b. The communication link 125-a and the communication link 125-b may include bi-directional links that enable both uplink and downlink communications. For example, the UE 115-a may transmit uplink signals (e.g., uplink transmissions), such as uplink control signals or uplink data signals, to the network entity 105-a using the communication link 125-a and the network entity 105-a may transmit downlink signals (e.g., downlink transmissions), such as downlink control signals or downlink data signals, to the UE 115-a using the communication link 125-a. The UE 115-a may transmit uplink signals (e.g., uplink transmissions), such as uplink control signals or uplink data signals, to the network entity 105-b using the communication link 125-b and the network entity 105-b may transmit downlink signals (e.g., downlink transmissions), such as downlink control signals or downlink data signals, to the UE 115-a using the communication link 125-b.

In some examples, each network entity 105-a may provide multiple cells 205. For example, the network entity 105-a may provide a cell 205-a, a cell 205-b, a cell 205-c, and a cell 205-d. In some examples, the network entity 105-b may provide a cell 205-e, a cell 205-f, a cell 205-g, and a cell 205-h. In some examples, the UE 115-a may communicate with a single cell (e.g., may be in the RRC connected state with a single cell 205). In some examples, the UE 115-a may communicate with multiple cells (e.g., may be in the RRC connected state with) via carrier aggregation as described herein. In some examples, the UE 115-a may be served by one or more cells 205 associated with the network entity 105-a (e.g., one of the cells may be the PCell and one or more other cells 205 may be SCells). In some examples, the UE 115-a may be served by one or more cells 205 associated with the network entity 105-a (e.g., one or more of the cells 205 associated with the network entity 105-a may be the MSG and one of the cells 205 provided by the network entity 105-a may be the PCell) and one or more cells associated with the network entity 105-b (e.g., the cells 205 associated with the network entity 105-b may be the SCG and one of the cells provided by the network entity 105-b may be the PSCell).

Cells 205 may include macro cells and small cells. Macro cells may provide wider geographic coverage and may operate in lower frequency ranges such as frequency range 1 (FR1) or the lower ranges of frequency range 3-1 (FR3-1) as compared to small cells. FR1 may include the sub-6 GHz band and FR3 may include 7.125 GHz to 24.25 GHz. Cells 205 may also include small cells. Small cells may operate at higher frequencies than macro cells (e.g., in the higher ranges of FR3 and in frequency range 2 (FR2)). FR2 may include 24.25 GHz to 71.0 GHz. Macro cells may provide blanket coverage to a large geographic area, and small cells may provide high data rates for UE traffic in smaller geographic areas than a macro cell. Some cells (e.g., small cells) may implement NES techniques. For example, the UE 115-a may be in the RRC connected state with the cell 205-a, and the cell 205-a may implement NES techniques. As described herein, in some examples, the UE 115-a may be in the RRC connected state with multiple cells 205 (e.g., including the cell 205-a) and one or more of the cells 205 with which the UE 115-a is in the RRC connected state may implement NES techniques.

NES techniques may involve refraining from transmission of signals 215 such as SSBs, SI, or paging messages (or on-demand or infrequent transmission of signals 215 such as SSBs or SI). NES techniques may involve refraining from monitoring of ROs and/or cell WUS occasions and/or an absence of ROs or cell WUS occasions. Accordingly, in some examples, the UE 115-a may be unable to camp on a cell (e.g., the cell 205-a) that implements NES techniques (e.g., as the cell may not provide SSBs, SI, (paging messages and/or may not monitor for or provide ROs or cell WUSs). As described herein, small cells may operate at higher frequencies, and thus may provide higher data rates. Connected mode mobility procedures (such as handover from a macro cell to a small cell) may be used to direct connections to small cells after camping on macro cells, but such procedures may involve extra signaling overhead, latency, and power consumption.

Control information 210 (e.g., RRC signaling) may indicate the type of cell (e.g., a small cell) and/or whether the cell 205-a implements NES techniques. In some examples, where a UE 115-a is served by the cell 205-a that does not support camping, the control information 210 may indicate and/or configure the UE 115-a to switch to camping on another cell 205 (such as a macro cell) when the RRC connection with the cell 205-a is released or suspended. For example, the cell 205-b may support UE camping in the RRC inactive or idle state (e.g., the cell 205-b may provide paging messages, SSBs, and/or SI and/or may provide and monitor for ROs and/or cell WUS occasions while the UE 115-a is in the RRC idle or inactive state with the cell 205-b). In some examples, the control information 210 may bar access to the cell 205-a (e.g., when the cell 205-a implements NES techniques that do not support the UE 115-a camping on the cell 205-a). As another example, the control information 210 may provide an information element (IE) RedirectedCarrierInfo that indicates which carrier (e.g., cell) to transition to, where the control information 210 may be an RRC release message sent from the cell 205-a. As another example, the control information 210 may provide an IE cellReselectionPriorities that provides higher/highest priority to cells (such as the cell 205-b) that support the UE 115-a camping, where the control information 210 may be an RRC release message sent from the cell 205-a. Although described with reference to transitioning from the RRC active or connected state with a single cell, as described herein, in some examples, the UE 115-a may transition from the RRC active or connected state with multiple cells 205 which may implement NES techniques (and/or may be small cells).

Traffic involving the UE 115-a may be correlated. In some examples, starting from a first time instance, the UE 115-a may experience a few seconds (e.g., N1 seconds) of idleness in traffic that may lead to a transition to an RRC idle or inactive state from the RRC active state (e.g., the RRC connected state) with a cell (e.g., the cell 205-a). More traffic for the UE 115-a that is part of a same overall application or traffic source may arrive after the few idle seconds (e.g., after N2 seconds after the first time instance, where N2>N1). In such scenarios, sending the UE 115-a to camp on a macro cell (e.g., the cell 205-b) after transitioning out of the RRC connected state with a small cell (e.g., the cell 205-a) and then transitioning the UE 115-a back to connection with the cell 205-a when the additional traffic arrives may involve high signaling overhead and energy consumption (associated with multiple cell reselections and handovers). Accordingly, as described herein, a cell (such as the cell 205-a) that implements NES techniques (such as a small cell) may allow temporary camping on the cell. Although described with reference to temporary camping on a single cell (e.g., the cell 205-a), as described herein, in some examples, the UE 115-a may transition from the RRC connected state with multiple cells 205 and may temporarily camp on two or more cells 205 of the multiple cells 205 in the RRC idle or inactive state.

In some examples, if the UE 115-a transitions from the RRC connected state with the cell 205-a (or multiple cells including the cell 205-a) at time instance t1, the UE 115-a may camp on the cell 205-a (or multiple cells including the cell 205-a) for a timer duration 250 (e.g., which may be configured as a timer at the UE 115-a). In some examples, the timer duration 250 may be indicated to the UE 115-a in an RRC release/suspend message from the cell 205-a (e.g., the control information 210). After the expiry of the timer duration 250 at the second time instance t2 (e.g., and if the UE 115-a does not receive a paging message 255 from the cell 205-a and/or one of the other cells on which the UE 115-a is camped), the UE 115-a may stop camping on the cell 205-a and may perform a cell reselection procedure 245 with another cell (e.g., the cell 205-b). For example, the selected cell may be a macro cell or a cell that does not implement NES techniques. After the expiry of the timer duration 250 at the second time instance t2, the UE 115-a may assume camping/access to the cell 205-a to be barred. In some examples, the UE 115-a may use the RedirectedCarrierInfo and/or the cellReselectionPriorities IEs in an RRC release/suspend message (e.g., the control information 210) to perform the cell reselection procedure 245. In some examples, if the UE 115-a receives a paging message 255 from the cell 205-a during the timer duration 250 after the first time instance t1, the UE 115-a may transition back to the RRC connected state with the cell 205-a (e.g., may perform a RACH procedure with the cell 205-a and/or may monitor a PDCCH occasion for downlink control information (DCI) indicating a resource to monitor for downlink data).

As another example, if the UE 115-a transitions from the RRC connected state with the cell 205-a (or multiple cells including the cell 205-a) at time instance t1, the UE 115-a may camp on the cell 205-a (or multiple cells including the cell 205-a) until receiving a control message 220 that indicates to terminate camping on the cell 205-a (or the multiple cells including the cell 205-a). In some examples, the control message 220 may extend the timer duration (e.g., the UE 115-a may camp on the cell 205-a until a timer duration 250 expires without resetting or suspending of the timer duration 250). Reception of the control message 220 that indicates to terminate camping on the cell 205-a may indicate that cell reselection criteria (e.g., as indicated in the RedirectedCarrierInfo and/or the cellReselectionPriorities IEs in an RRC release/suspend message such as in the control information 210) may become effective, and the UE 115-a may accordingly perform the cell reselection procedure 245. In some examples, the control message 220 may indicate the UE 115-a may continue camping (e.g., may suspend or reset the timer duration 250). For example, an absence of a suspend/reset indication within the timer duration 250 may indicate for the UE 115-a to stop camping on the cell 205-a at the end of the timer duration and perform the cell reselection procedure 245.

In some examples, the control message 220 may be a broadcast message (e.g., may indicate that the cell 205-a is entering an NES mode in which camping is not supported and/or may indicate to all UEs 115 camped on the cell 205-a that the cell 205-a is extending the temporary camping duration and/or extending a period until the cell 205-a will enter an NES mode). In some examples, the control message 220 may be a group-common (e.g., applicable to a group of UEs 115 including the UE 115-a served by and/or camped on the cell 205-a). In some examples, the control message 220 may be targeted to the UE 115-a (e.g., may include an identifier for the UE 115-a such as a radio network temporary identifier (RNTI) for the UE 115-a). In some examples, the control message 220 may be a paging early indication message (PEI), a WUS, a low power WUS, a short message (e.g., leveraging small data transmission (SDT) framework), a paging message, a PDCCH message, or a physical downlink shared channel (PDSCH) message. In some examples, the UE 115-a may be assigned an RNTI (e.g., via control information 210) which may be valid for an indicated duration of time and may be used for monitoring for control messages 220 from the cell 205-a while camping on the cell 205-a.

In some examples, multiple methods of signaling (e.g., broadcast and UE-dedicated signaling) the control message 220 may be supported. In such examples, conflict resolution techniques may be implemented. For example, a later dedicated notification may override a group-common or broadcast control message, or vice versa. For example, a later dedicated control message indicating to terminate camping on the cell 205-a may override an early group-common or broadcast control message indicating to extend camping on the cell 205-a. In some examples, any later control message may override an earlier control message. In some examples, a flag may be included to notify whether and/or which control message has a higher priority.

In some examples, broadcast and/or group common control messages 220 (e.g., indications of whether to extend or terminate camping on the cell 205-a) may be implicit or indirect. For example, the broadcast and/or group common control messages 220 may indicate a state of the cell 205-a (e.g., NES operation or normal operation and/or deactivation or (re)configuration of features associated with camping (such as SSB transmission, SI monitoring, RO monitoring, WUS monitoring, paging transmission, and/or cell discontinuous reception (DRX) or discontinuous transmission (DTX)). Such an indication of the configuration of the cell 205-a may indicate to the UE 115-a whether to terminate camping on the cell 205-a or to continue camping on the cell 205-a.

In some examples, the UE 115-a may predict future traffic or traffic patterns for the UE 115-a. In some examples, the UE 115-a may transmit a request 225 that indicates a suggested value (e.g., a minimum value, maximum value, mean value, range of values, or exact value) for the timer duration 250. For example, the UE 115-a may provide the request 225 that indicates the suggested timer duration while in the RRC connected state with the cell 205-a (e.g., before the first time instance t1). The control information 210 may indicate the timer duration 250 based on (e.g., accounting for the UE suggested timer duration in the request 225).

While in the RRC idle or inactive state (e.g., after the first time instance t1), the UE 115-a may send UE control information 230 to the cell 205-a. For example, the UE control information 230 may request to extend or reset the timer duration 250. As another example, the UE control information 230 may indicate the UE 115-a does not expect any uplink traffic (and accordingly that the UE 115-a may transition to camping on another cell earlier than the end of the timer duration 250). As another example, the UE control information 230 may indicate the UE 115-a has selected or will select another cell 205 for camping. In such examples, the UE control information 230 may be sent after performance of the cell reselection procedure 245. The UE control information 230 may be sent or conveyed via a Msg1 of a RACH procedure, a Msg3 of a RACH procedure, a MSGA preamble or payload of a RACH procedure, a scheduling request (SR), a configured grant (CG) PUSCH (CG-PUSCH) resource (e.g., leveraging SDT framework), an uplink WUS, a low power uplink WUS, and/or any uplink signaling (such as via a waveform modulated via on-off keying (OOK)). The cell 205-a may provide an acknowledgment 235 for the UE control information 230.

In some examples, temporary camping on the cell 205-a may be associated with a separate cell reselection criteria and/or configuration from camping on a cell 205 that does not implement NES techniques (e.g., in terms of link quality, link strength, thresholds). For example, the UE 115-a may be configured with a first cell reselection configuration to apply when camping on a first type of cell (e.g., macro cells or cells that are not indicated as implementing NES techniques) and a second cell reselection configuration to apply when camping on a second type of cell (e.g., small cells or cells indicated as implementing NES techniques). For example, the second cell reselection configuration may include beam-specific criteria or thresholds; speed/mobility dependent criteria (e.g., applicable if the UE 115-a remains stationary or does not move beyond a speed or distance threshold or the second cell reselection configuration may include speed-dependent thresholds and parameters); and/or location/zone dependent criteria (e.g., for selection of cells).

During temporary camping on the cell 205-a (e.g., between the first time instance t1 and the second time instance t2), the UE 115-a may expect that the cell 205-a may support paging (e.g., given that a small quantity of UEs 115 may temporarily camp on the cell 205-a). In some examples, the supported paging during a temporary camping period may be simplified (e.g., may be an LP-WUS or PEI-only paging, replacing a PDCCH scrambled with the cell RNTI (C-RNTI) of the UE 115-a), where such simplified paging may be valid during the temporary camping period and may not be valid while camping on a cell that is not implementing NES techniques. In some examples, the control information 210 may provide a configuration for monitoring and receiving such paging messages (e.g., via LP-WUSs or PEI).

During temporary camping on the cell 205-a (e.g., between the first time instance t1 and the second time instance t2), the UE 115-a may expect that the cell 205-a may support a RACH configuration (e.g., may monitor for one or more configured ROs). In some examples, the RACH configuration may be based on low power uplink WUSs, which may be configured for a subset of beam directions.

In some examples, during temporary camping on the cell 205-a (e.g., between the first time instance t1 and the second time instance t2), the UE 115-a may expect that SI associated with the cell does not change as compared to when the UE 115-a is in the RRC active state with the cell 205-a. For example, the UE 115-a may expect that previously received SI for the cell 205-a while the UE 115-a as in the RRC active state with the cell 205-a is valid while the UE 115-a is temporarily camping on the cell 205-a. Accordingly, the cell 205-a may save energy via refraining from transmission of the SI during the temporary camping period. In some examples, during temporary camping on the cell 205-a (e.g., between the first time instance t1 and the second time instance t2), if the SI changes, the cell 205-a may transmit a control message (e.g., short message) indicating that the SI for the cell 205-a has changed. In some such examples, the cell 205-a may refrain from transmitting (e.g., not transmit) the updated SI during the temporary camping period. In some such examples, the cell 205-a may transmit the updated SI during the temporary camping period. In some examples, an indication of updated SI from the cell 205-a may be treated by the UE 115-a as the control message 220 that indicates to terminate camping on the cell 205-a.

During temporary camping on the cell 205-a (e.g., between the first time instance t1 and the second time instance t2), the UE 115-a may expect that the cell 205-a may transmit signals 215 (such as SSBs or other downlink reference signals such as channel state information (CSI) reference signals (CSI-RS) or tracking reference signals (TRSs)) in accordance with an indicated configuration. In some examples, the control information 210 may indicate the reference signal configuration for the cell 205-a during the temporary camping period. During temporary camping on the cell 205-a (e.g., between the first time instance t1 and the second time instance t2), the cell 205-a may support on-demand SSBs (e.g., the UE 115-a may request an SSB). During temporary camping on the cell 205-a (e.g., between the first time instance t1 and the second time instance t2), the cell 205-a may transmit SSBs or other downlink reference signals using a low power wake up transmission (WUT) (potentially using a defined waveform type such as OOK). In some examples, the UE 115-a may monitor for signals 215 (e.g., SSBs) from other cells 205 while temporarily camping on the cell 205-a in order to select a cell (or multiple cells) for the cell reselection procedure 245.

In some examples, the UE 115-a may be configured with (e.g., via the control information 210 or other RRC signaling) a set of configurations that are valid during temporary camping on a cell, where the configurations may indicate types of signaling and/or resources for such signaling the UE 115-a may receive from the cell (e.g., configurations for SSBs, CSI-RSs, TRSs, paging-type messages) and the UE 115-b may transmit to the cell (e.g., configurations for cell WUSs, RACH configurations), and/or cell reselection configurations. In some examples, multiple candidate configurations may be configured for the UE 115-a (e.g., via RRC signaling while in the RRC active state), and the release or suspend message from the cell 205-a (e.g., the control information 210) may indicate which configured candidate configuration to apply during the temporary camping on the cell 205-a. After termination of camping on the cell 205-a, the UE 115-a may determine that the indicated set of configurations for temporary camping on the cell 205-a are not valid, and the UE 115-a may apply a different set of configurations (e.g., for cell reselection with a different cell). For example, the different set of configurations may be indicated as a default configuration in SI sent by the cell 205-a, in the release or suspend message from the cell 205-a (e.g., the control information 210), and/or in SI sent by another cell (e.g., the cell 205 selected in the cell reselection procedure 245). For example, the UE 115-a may apply a different set of configurations to camping on the cell selected in the cell reselection procedure 245.

As described herein, at the termination of temporary camping at the second time instance t2, the UE 115-a may perform a cell reselection procedure 245. In accordance with the cell reselection procedure 245, the UE 115-a may reselect to another cell 205 (such as the cell 205-b), which may be a macro-cell, or another small cell or cell that implements NES techniques. In some examples, the reselected cell may be within the same cell group as the cell 205-a (e.g., may be in the MCG where the cell on which the UE was camping was in the MCG). In some examples, the reselected cell may be in a different cell group (e.g., may be provided by a different network entity 105 such as the network entity 105-b). In some examples, the UE 115-a may reselect to multiple cells 205 (e.g., the UE 115-a may select to camp on or enter the RRC connected state with multiple cells 205).

In some examples, the UE 115-a may be indicated/configured with the conditions and/or instructions for the behavior of the UE 115-a for temporary camping on the cell 205-a. For example, such conditions and/or instructions may include a list of one or multiple cells 205, frequencies, cell types, along with priorities and other related parameters (such as channel quality/strength thresholds, and offsets). In some examples, such conditions and/or instructions may be provided to the UE 115-a before the UE 115-a enters the RRC idle or inactive mode and camps on the cell 205-a (e.g., via the control information 210 which may be a release or suspend message). In some examples, such conditions and/or instructions may be provided to the UE 115-a via the control message 220 that indicates for the UE 115-a to terminate camping on the cell 205-a. In some examples, such conditions and/or instructions may be provided to the UE 115-a via SI from the cell 205-a.

In some examples, the UE 115-a may send an acknowledgment message 240 that acknowledges receipt of the control message 220 and that indicates for the UE 115-a to terminate camping on the cell 205-a. For example, the acknowledgment message may be used to prevent mismatch between the UE 115-a and the cell 205-a (e.g., to prevent scenarios where the UE 115-a misses the control message 220, and thus the UE continues camping on the cell 205-a when the cell 205-a no longer supports camping on the cell 205-a). For example, the cell 205-a may refrain from implementing NES techniques until reception of the acknowledgment message 240.

In some examples, the UE 115-a may provide an indication 260 to the newly selected cell 205 (e.g., selected via the cell reselection procedure 245) that notifies the newly selected cell 205 that the UE has selected the newly selected cell (e.g., via the cell reselection procedure 245). For example, the UE 115-a may transmit the indication 260 via the communication link 125-a where the newly selected cell is provided by the network entity 105-a. As another example, the UE 115-a may transmit the indication 260 via the communication link 125-b where the newly selected cell is provided by the network entity 105-b. In response to the indication, the newly selected cell 205 may indicate the selection of the newly selected cell 205 to the cell 205-a (e.g., via a backhaul signal). Accordingly, based on the indication from the newly selected cell (via the backhaul signal), the cell 205-a may be informed that the UE 115-a has terminated camping on the cell 205-a and has selected the new cell. For example, the indication 260 may be sent via an uplink WUS, a low power uplink WUS, a MSG1 of a RACH procedure, a MSG3 of a RACH procedure, or a MSGA of a RACH procedure.

In some examples, the cell 205-a may implement “keep-alive signaling.” For example, such “keep-alive signaling” may be a waveform transmitted by the cell 205-a (e.g., that may be transmitted via a wake up radio at the cell 205-a and received via a wake up radio at the UE 115-a). In some examples, if the cell stops transmitting the “keep-alive signaling” (e.g., a duration passes without reception of the “keep-alive signaling”), the UE 115-a may perform the cell reselection procedure 245. In some examples, the cell 205-a may continue to transmit the “keep-alive signaling” which may carry an indication that one or more UEs or groups of UEs including the UE 115-a are barred/terminated from the cell 205-a, which may indicate for the UE 115-a to perform the cell reselection procedure 245.

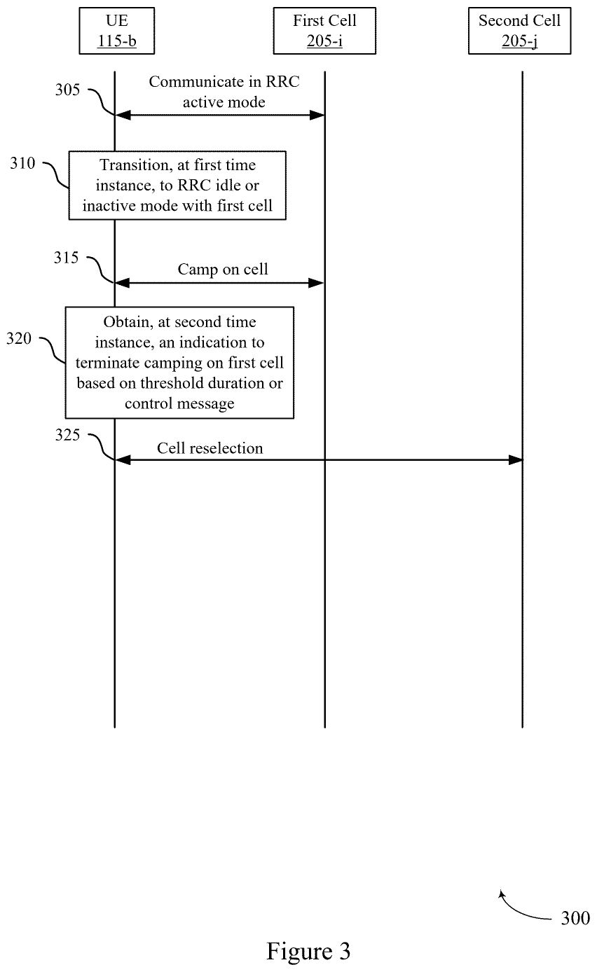

FIG. 3 shows an example of a process flow 300 that supports temporary camping on a cell. The process flow 300 may implement or be implemented by the wireless communication system 100 or the signaling configuration 200. For example, the process flow 300 may include a UE 115-b, which may be an example of a UE 115 as described herein. The process flow 300 may include a first cell 205-i and second cell 205-j, which may be examples of cells 205 as described herein.

In the following description of the process flow 300, the operations between the UE 115-b, the first cell 205-i, and the second cell 205-j may be performed in different orders or at different times. Some operations may also be left out of the process flow 300, or other operations may be added. Although the UE 115-b, the first cell 205-i, and the second cell 205-j are shown performing the operations of the process flow 300, some aspects of some operations may also be performed by one or more other entities.

At 305, the UE 115-b may communicate in an RRC active state with a first set of cells including the first cell 205-i. For example, the UE 115-a may communicate with multiple cells in carrier aggregation, or the UE 115-a may communicate with a single cell (e.g., the first cell 205-i).

At 310, the UE 115-b may obtain, at a first time instance, control information that indicates to transition from the RRC connected state with the set of cells to an RRC idle or inactive state associated with camping on the first cell 205-i. For example, the UE 115-b may receive an RRC release or suspend message from the first cell 205-i and/or one of the other cells of the first set of cells that indicates to transition to the RRC idle or inactive state. For example, the control information may be the control information 210 as described with reference to FIG. 2.

At 315, the UE 115-b may camp on the first cell 205-i. In some examples, the UE 115-b may camp on multiple cells including the first cell 205-i, where the UE transitioned from the RRC active state to the RRC idle or inactive state with the multiple cells at 310.

At 320, the UE 115-b may obtain, at a second time instance while in the RRC idle or inactive state (e.g., while camping on the first cell 205-i), an indication to terminate camping on the first cell 205-i based on satisfaction of a threshold duration after the first time instance or receipt of a control message from the first cell 205-i. For example, the threshold duration may be the timer duration 250 as described with reference to FIG. 2. In some examples, the UE 115-b may output, for the first cell 205-i, an acknowledgment (ACK) message in response to the control message.

At 325, the UE 115-b may perform, based on the indication at 320 to terminate camping on the first cell, a cell reselection procedure with the second cell 205-j.

In some examples, the control information at 310 may include the threshold duration (e.g., may indicate a timer duration).

In some examples, the UE 115-b may obtain, from the first cell 205-i after the first time instance and before the second time instance, a second control message that resets or extends the threshold duration. For example, “keep alive signaling” may indicate to reset or extend the threshold duration (e.g., the timer duration).

In some examples, the control message at 320 may be received via a broadcast transmission from the first cell 205-i. In some examples, the control message at 320 may be received via a downlink message from the first cell that includes an identifier (e.g., a cell-RNTI or a group identifier) associated with the UE 115-b.

In some examples, the UE 115-b may obtain second control information that indicates the first cell 205-i is operating in accordance with an energy saving configuration (e.g., in accordance with one or more NES techniques), and obtaining the indication to terminate camping on the first cell may be based on the second control information. For example, the UE 115-b may temporarily camp on the first cell 205-i based on the indication that the first cell 205-i is operating in accordance with an energy saving configuration. In some examples, the UE 115-b may obtain second control information that indicates that the first cell 205-i will enter an NES mode, and the UE may perform the cell reselection procedure based on obtaining the control information that indicates that the first will enter an NES mode. For example, the control message at 320 may indicate that (and/or when) the first cell 205-i will enter the NES mode.

In some examples, the UE 115-b may output, for the first cell 205-i while in the RRC connected state with the first cell and prior to the first time instance, a second control message that indicates a suggested or recommended threshold duration, and the threshold duration may be on the suggested threshold duration. For example, control information received from the first cell 205-i may indicate the threshold duration based on the suggested threshold duration indicated in the second control message.

In some examples, the UE 115-b may output, after the first time instance and before the second time instance, a second control message for the first cell 205-i that resets or extends the threshold duration or indicates that the UE 115-b will terminate camping on the first cell 205-i. In some examples, the UE 115-b may obtain, from the first cell 205-i, an ACK message in response to the second control message. In some examples, the UE 115-b may transmit the second control message via a RACH message, an SR, an uplink WUS, or an SDT.

In some examples, performing the cell reselection procedure at 325 may involve performing the cell reselection procedure in accordance with a first cell reselection configuration associated with camping on a cell associated with a first frequency range (e.g., on a small cell) that is different from a second cell reselection configuration associated with camping on a cell of a second frequency range (e.g., on macro cells), where the second frequency range is lower than the first frequency range.

In some examples, the UE 115-b may monitor for, from the first cell 205-i after the first time instance and prior to the second time instance, paging messages, SI, SSBs, or a combination thereof. In some examples, the UE 115-b may obtain an indication of a signaling configuration associated with camping on the first cell (e.g., associated with temporary camping on the first cell 205-i), and monitoring for the paging messages, SI, and/or SSBs is based on the signaling configuration.

In some examples, the UE 115-b may obtain second control information that indicates one or more parameters associated with the cell reselection procedure. The one or more parameters may include a list of candidate cells, priorities associated with candidate cells, channel quality threshold information, or a combination thereof.

In some examples, the UE 115-b may output, for the second cell 205-j, an indication of selection of the second cell in accordance with the cell reselection procedure.

In some examples, performing the cell reselection procedure may be based on an absence of a control signal from the first cell 205-i during the threshold duration (e.g., an absence of a keep-alive signal), where the control signal may be associated with resetting the threshold duration.

In some examples, the RRC idle or inactive state is further associated with camping on a third cell of the set of cells (e.g., the UE 115-b may camp on multiple cells), and the indication at the second time instance further indicates to terminate camping on the third cell.

In some examples, the first cell 205-i is associated with a first frequency range (e.g., is a small cell) and the second cell 205-j is associated with a second frequency range that is lower than the first frequency range (e.g., the second cell is a macro cell). In some examples, the first cell 205-i and the second cell 205-j may both be small cells.

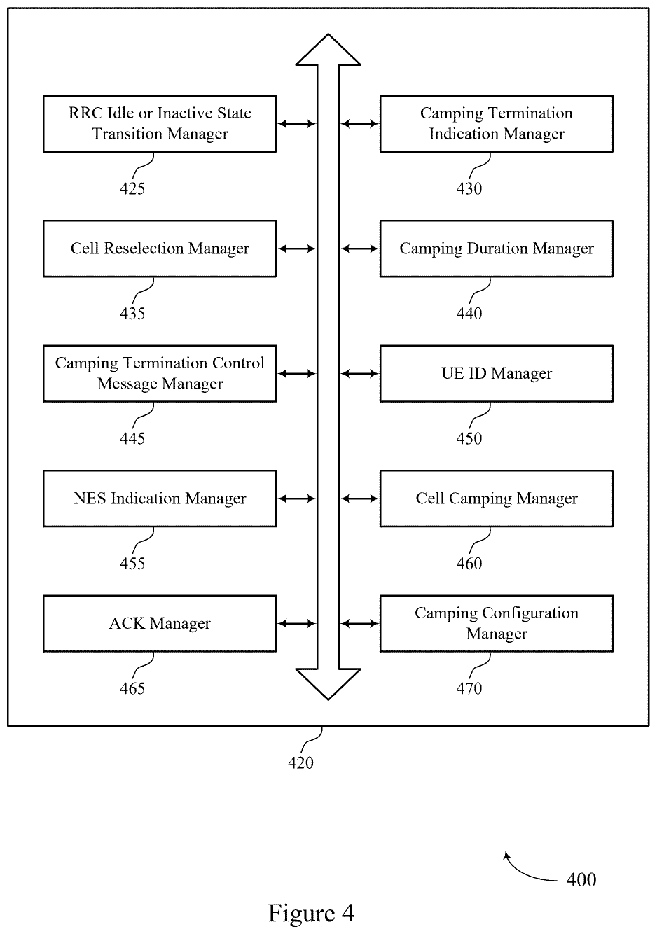

FIG. 4 shows an example 400 of a processing system 420 that supports temporary camping on a cell. A processing system 420 may be an example of a processing system 140 (such as of a UE 115) and may include an RRC idle or inactive state transition manager 425, a camping termination indication manager 430, a cell reselection manager 435, a camping duration manager 440, a camping termination control message manager 445, a UE ID manager 450, a NES indication manager 455, a cell camping manager 460, an ACK manager 465, a camping configuration manager 470, or any combination thereof. A processing system 420, or various component thereof, may be an example of means for performing (such as a means for causing a UE 115 to perform) various techniques described herein.

The RRC idle or inactive state transition manager 425 may be configured to cause the UE 115 to obtain, at a first time instance, control information that indicates to transition from an RRC connected state with a set of cells to an RRC idle or inactive state associated with camping on a first cell of the set of cells. The camping termination indication manager 430 may be configured to cause the UE 115 to obtain, at a second time instance while in the RRC idle or inactive state, an indication to terminate camping on the first cell based on satisfaction of a threshold duration after the first time instance or receipt of a control message from the first cell. The cell reselection manager 435 may be configured to cause the UE 115 to perform, based on the indication to terminate camping on the first cell, a cell reselection procedure with a second cell.

In some examples, the control information further indicates the threshold duration.

In some examples, the camping duration manager 440 may be configured to cause the UE 115 to obtain, from the first cell after the first time instance and before the second time instance, a second control message that resets or extends the threshold duration.

In some examples, the camping termination control message manager 445 may be configured to cause the UE 115 to obtain a broadcast transmission from the first cell that includes the control message.

In some examples, the UE ID manager 450 may be configured to cause the UE 115 to obtain a transmission from the first cell that includes an identifier associated with the UE.

In some examples, the NES indication manager 455 may be configured to cause the UE 115 to obtain second control information that indicates the first cell is operating in accordance with an energy saving configuration, where obtaining the indication to terminate camping on the first cell is based on the second control information.

In some examples, the camping duration manager 440 may be configured to cause the UE 115 to output, for the first cell while in the RRC connected state with the first cell and prior to the first time instance, a second control message that indicates a suggested threshold duration, where the threshold duration is based on the suggested threshold duration.

In some examples, the camping duration manager 440 may be configured to cause the UE 115 to output, after the first time instance and before the second time instance, a second control message that resets or extends the threshold duration or indicates that the UE will terminate camping on the first cell.

In some examples, the ACK manager 465 may be configured to cause the UE 115 to obtain, from the first cell, an acknowledgment message in response to the second control message.

In some examples, the camping duration manager 440 may be configured to cause the UE 115 to transmit the second control message via a random access channel message, a scheduling request, an uplink WUS, or an SDT.

In some examples, to support performing the cell reselection procedure, the cell reselection manager 435 may be configured to cause the UE 115 to perform the cell reselection procedure in accordance with a first cell reselection configuration associated with camping on a cell associated with a first frequency range that is different from a second cell reselection configuration associated with camping on a cell of a second frequency range, where the second frequency range is lower than the first frequency range.

In some examples, the cell camping manager 460 may be configured to cause the UE 115 to monitor for, from the first cell after the first time instance and prior to the second time instance, paging messages, SI, SSBs, or a combination thereof.

In some examples, the camping configuration manager 470 may be configured to cause the UE 115 to obtain an indication of a signaling configuration associated with camping on the first cell, where the monitoring is based on the signaling configuration.

In some examples, the cell reselection manager 435 may be configured to cause the UE 115 to obtain second control information that indicates one or more parameters associated with the cell reselection procedure, where the one or more parameters include a list of candidate cells, priorities associated with candidate cells, channel quality threshold information, or a combination thereof.

In some examples, the ACK manager 465 may be configured to cause the UE 115 to output, for the first cell, an acknowledgment message in response to the control message.

In some examples, the cell reselection manager 435 may be configured to cause the UE 115 to output, to the second cell, an indication of selection of the second cell in accordance with the cell reselection procedure.

In some examples, performing the cell reselection procedure is based on an absence of a control signal from the first cell during the threshold duration, the control signal associated with resetting the threshold duration.

In some examples, the RRC idle or inactive state is further associated with camping on a third cell of the set of cells. In some examples, the indication at the second time instance further indicates to terminate camping on the third cell.

In some examples, the first cell is associated with a first frequency range. In some examples, the second cell is associated with a second frequency range that is lower than the first frequency range.

A processing system 420 may include or be a component of one or more chips, systems-on-chips (SoCs), chipsets, packages, components, or devices that individually or collectively constitute or include a processing system. A processing system 420 may interface with other components of a processing system 420. For example, operations described with reference to a processing system 420, or various components thereof, may be performed by or with other such components, including a receiver, a transmitter, a transceiver, a modem, a user interface, a modulator/demodulator, an encoder/decoder, or any combination thereof (such as of the processing system 420, coupled with the processing system 420, of a processing system 420).

By including or configuring a processing system 420 for operation in a processing system 420 as described herein, the processing system 420 may support techniques for reduced latency, reduced power consumption, improved coordination between devices, longer battery life, and improved utilization of processing capability by enabling temporary camping on cells that implement NES techniques.

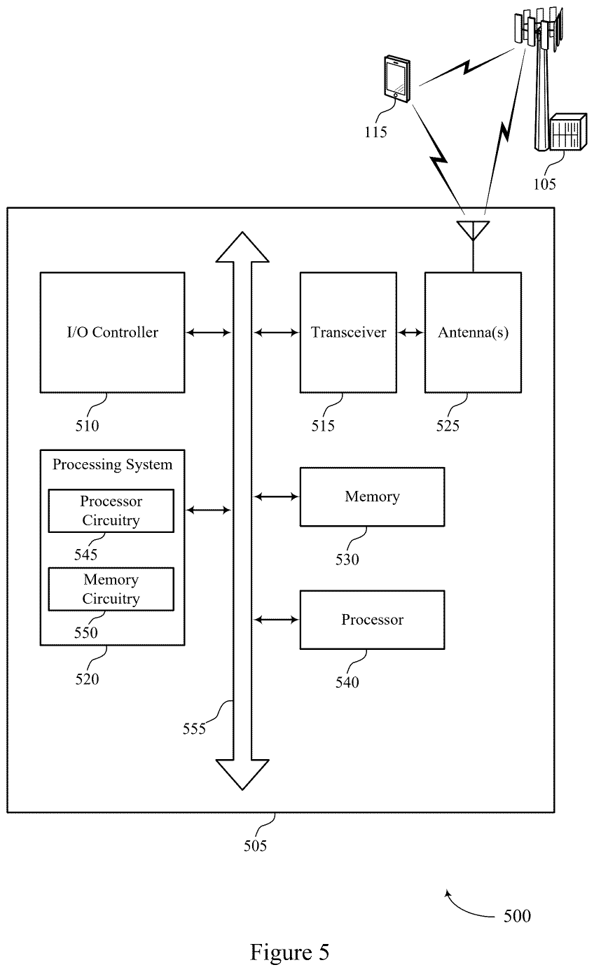

FIG. 5 shows an example of a system 500 including a device 505 that supports temporary camping on a cell. The device 505 may be an example of or include components of UE 115. The device 505 may communicate (such as wirelessly) with one or more other devices (such as network entities 105, UEs 115). The device 505 may include components for transmitting and receiving communication, which may include a processing system 520, an input/output (I/O) controller, such as an I/O controller 510, a transceiver 515, antenna(s) 525, a memory 530, and a processor 540. Components of the device 505 may be coupled (such as operatively, communicatively, functionally, electronically, electrically, in electronic communication) a bus 555.

The transceiver 515 may support bi-directional communication via antenna(s) 525, and may support transmission operations, reception operations, or both, as described herein. The transceiver 515 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 505). The transceiver 515 may modulate symbols and provide the modulated symbols to antenna(s) 525 for transmission, and demodulate symbols from signals received using antenna(s) 525.

The processor 540 may be a general-purpose processing component that supports various operations (such as applications) of the device 505. The memory 530 may be a general-purpose storage component that stores code executable by the processor 540. Such code may include instructions that, when executed by the processor 540, cause the device 505 to perform various functions (such as to support an application of the device 505). The I/O controller 510 may manage inputs and outputs for the device 505, may manage peripherals not integrated into the device 505, or may represent a physical connection (such as port) to an external peripheral. The processor 540 may interact with a modem, a keyboard, a mouse, a touchscreen, or other device (such as via I/O controller 510). In some implementations, a user may interact with the device 505 via the I/O controller 510 or via hardware components controlled by the I/O controller 510.

The processing system 520 may be an example of a processing system 140 or a processing system 420. For example, the processing system 520 may include processor circuitry 545 and memory circuitry 550 that stores code, and may be configured to cause the device 505 to perform operations that support temporary camping on a cell. Although the processing system 520 is illustrated as a separate component, which may involve a separate chip, chipset, or other module, in some implementations, one or more functions described with reference to the processing system 520 may be supported by or performed by a transceiver 515, antenna(s) 525, a processor 540, memory 530, or any combination thereof, such that a processing system 520 may include one or more of a transceiver 515, antenna(s) 525, a processor 540, memory 530, or any combination thereof.

By including or configuring the processing system 520 for operation in the device 505 as described herein, may support techniques for reduced latency, reduced power consumption, improved coordination between devices, longer battery life, and improved utilization of processing capability by enabling temporary camping on cells that implement NES techniques.

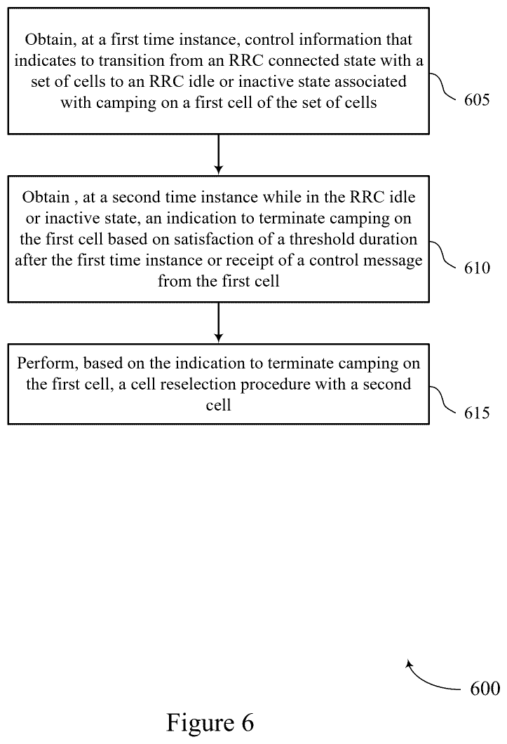

FIG. 6 shows an example of a method 600 that supports temporary camping on a cell. Operations of the method 600 may be performed by a UE or its components (such as using a processing system configured to cause the UE 115 to perform one or more of the operations) as described herein.

At 605, the method may include obtaining, at a first time instance, control information that indicates to transition from an RRC connected state with a set of cells to an RRC idle or inactive state associated with camping on a first cell of the set of cells. In some examples, aspects of the operations of 605 may be performed by an RRC idle or inactive state transition manager 425.

At 610, the method may include obtaining, at a second time instance while in the RRC idle or inactive state, an indication to terminate camping on the first cell based on satisfaction of a threshold duration after the first time instance or receipt of a control message from the first cell. In some examples, aspects of the operations of 610 may be performed by a camping termination indication manager 430.

At 615, the method may include performing, based on the indication to terminate camping on the first cell, a cell reselection procedure with a second cell. In some examples, aspects of the operations of 615 may be performed by a cell reselection manager 435.

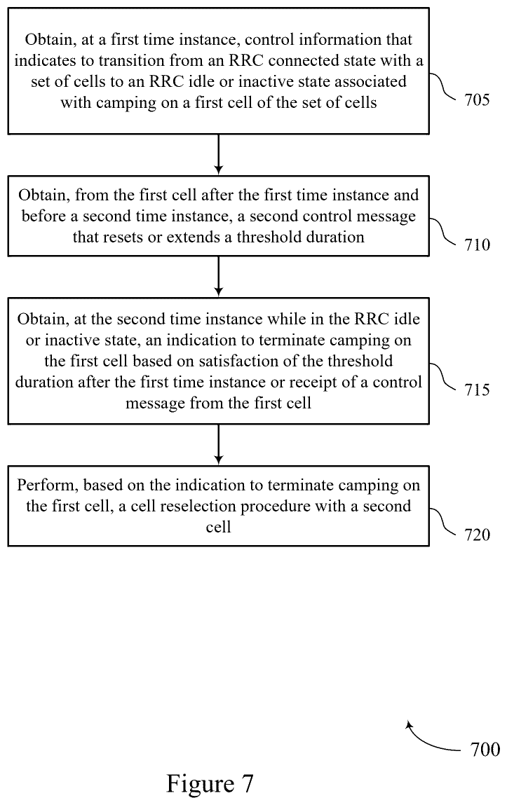

FIG. 7 shows an example of a method 700 that supports temporary camping on a cell. Operations of the method 700 may be performed by a UE or its components (such as using a processing system configured to cause the UE 115 to perform one or more of the operations) as described herein.

At 705, the method may include obtaining, at a first time instance, control information that indicates to transition from an RRC connected state with a set of cells to an RRC idle or inactive state associated with camping on a first cell of the set of cells. In some examples, aspects of the operations of 705 may be performed by an RRC idle or inactive state transition manager 425.

At 710, the method may include obtaining, from the first cell after the first time instance and before a second time instance, a second control message that resets or extends a threshold duration. In some examples, aspects of the operations of 710 may be performed by a camping duration manager 440.

At 715, the method may include obtaining, at the second time instance while in the RRC idle or inactive state, an indication to terminate camping on the first cell based on satisfaction of the threshold duration after the first time instance or receipt of a control message from the first cell. In some examples, aspects of the operations of 715 may be performed by a camping termination indication manager 430.

At 720, the method may include performing, based on the indication to terminate camping on the first cell, a cell reselection procedure with a second cell. In some examples, aspects of the operations of 720 may be performed by a cell reselection manager 435.

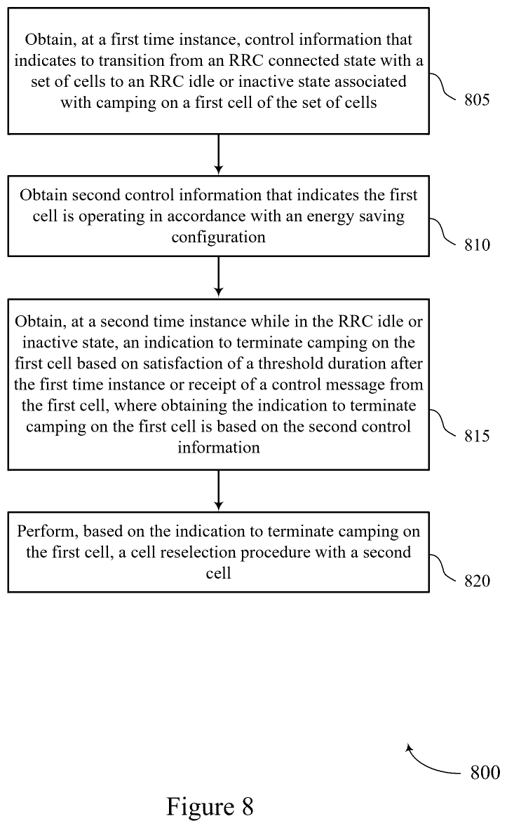

FIG. 8 shows an example of a method 800 that supports temporary camping on a cell. Operations of the method 800 may be performed by a UE or its components (such as using a processing system configured to cause the UE 115 to perform one or more of the operations) as described herein.

At 805, the method may include obtaining, at a first time instance, control information that indicates to transition from an RRC connected state with a set of cells to an RRC idle or inactive state associated with camping on a first cell of the set of cells. In some examples, aspects of the operations of 805 may be performed by an RRC idle or inactive state transition manager 425.

At 810, the method may include obtaining second control information that indicates the first cell is operating in accordance with an energy saving configuration. In some examples, aspects of the operations of 810 may be performed by a NES indication manager 455.

At 815, the method may include obtaining, at a second time instance while in the RRC idle or inactive state, an indication to terminate camping on the first cell based on satisfaction of a threshold duration after the first time instance or receipt of a control message from the first cell, where obtaining the indication to terminate camping on the first cell is based on the second control information. In some examples, aspects of the operations of 815 may be performed by a camping termination indication manager 430.

At 820, the method may include performing, based on the indication to terminate camping on the first cell, a cell reselection procedure with a second cell. In some examples, aspects of the operations of 820 may be performed by a cell reselection manager 435.

Implementation examples are described in the following numbered clauses:
Aspect 1: A method for wireless communications at a UE, comprising: obtaining, at a first time instance, control information that indicates to transition from an RRC connected state with a set of cells to an RRC idle or inactive state associated with camping on a first cell of the set of cells; obtaining, at a second time instance while in the RRC idle or inactive state, an indication to terminate camping on the first cell based at least in part on satisfaction of a threshold duration after the first time instance or receipt of a control message from the first cell; and performing, based at least in part on the indication to terminate camping on the first cell, a cell reselection procedure with a second cell.
Aspect 2: The method of aspect 1, wherein the control information further indicates the threshold duration.
Aspect 3: The method of any of aspects 1 through 2, further comprising: obtaining, from the first cell after the first time instance and before the second time instance, a second control message that resets or extends the threshold duration.
Aspect 4: The method of any of aspects 1 through 3, further comprising: obtaining a broadcast transmission from the first cell that comprises the control message.
Aspect 5: The method of any of aspects 1 through 3, further comprising: obtaining a transmission from the first cell that comprises an identifier associated with the UE.
Aspect 6: The method of any of aspects 1 through 5, further comprising: obtaining second control information that indicates the first cell is operating in accordance with an energy saving configuration, wherein obtaining the indication to terminate camping on the first cell is based at least in part on the second control information.
Aspect 7: The method of any of aspects 1 through 6, further comprising: outputting, for the first cell while in the RRC connected state with the first cell and prior to the first time instance, a second control message that indicates a suggested threshold duration, wherein the threshold duration is based at least in part on the suggested threshold duration.
Aspect 8: The method of any of aspects 1 through 7, further comprising: outputting, after the first time instance and before the second time instance, a second control message that resets or extends the threshold duration or indicates that the UE will terminate camping on the first cell.
Aspect 9: The method of aspect 8, further comprising: obtaining, from the first cell, an acknowledgment message in response to the second control message.
Aspect 10: The method of any of aspects 8 through 9, further comprising: transmitting the second control message via a random access channel message, a scheduling request, an uplink WUS, or an SDT.
Aspect 11: The method of any of aspects 1 through 10, wherein performing the cell reselection procedure comprises: performing the cell reselection procedure in accordance with a first cell reselection configuration associated with camping on a cell associated with a first frequency range that is different from a second cell reselection configuration associated with camping on a cell of a second frequency range, wherein the second frequency range is lower than the first frequency range.
Aspect 12: The method of any of aspects 1 through 11, further comprising: monitoring for, from the first cell after the first time instance and prior to the second time instance, paging messages, SI, SSBs, or a combination thereof.
Aspect 13: The method of aspect 12, further comprising: obtaining an indication of a signaling configuration associated with camping on the first cell, wherein the monitoring is based at least in part on the signaling configuration.
Aspect 14: The method of any of aspects 1 through 13, further comprising: obtaining second control information that indicates one or more parameters associated with the cell reselection procedure, wherein the one or more parameters comprise a list of candidate cells, priorities associated with candidate cells, channel quality threshold information, or a combination thereof.
Aspect 15: The method of any of aspects 1 through 14, further comprising: outputting, for the first cell, an acknowledgment message in response to the control message.
Aspect 16: The method of any of aspects 1 through 15, further comprising: outputting, to the second cell, an indication of selection of the second cell in accordance with the cell reselection procedure.
Aspect 17: The method of any of aspects 1 through 16, wherein performing the cell reselection procedure is based at least in part on an absence of a control signal from the first cell during the threshold duration, the control signal associated with resetting the threshold duration.
Aspect 18: The method of any of aspects 1 through 17, wherein the RRC idle or inactive state is further associated with camping on a third cell of the set of cells, and the indication at the second time instance further indicates to terminate camping on the third cell.
Aspect 19: The method of any of aspects 1 through 18, wherein the first cell is associated with a first frequency range, and the second cell is associated with a second frequency range that is lower than the first frequency range.
Aspect 20: A UE for wireless communications, comprising a processing system that includes processor circuitry and memory circuitry that stores code, the processing system configured to cause the UE to perform a method of any of aspects 1 through 19.
Aspect 21: A UE for wireless communications, comprising at least one means for performing a method of any of aspects 1 through 19.
Aspect 22: A non-transitory computer-readable medium storing code for wireless communications, the code comprising instructions executable by one or more processors to perform a method of any of aspects 1 through 19.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
obtain, at a first time instance, control information that indicates to transition from a radio resource control (RRC) connected state with a set of cells to an RRC idle or inactive state associated with camping on a first cell of the set of cells;
obtain, at a second time instance while in the RRC idle or inactive state, an indication to terminate camping on the first cell based at least in part on satisfaction of a threshold duration after the first time instance or receipt of a control message from the first cell; and
perform, based at least in part on the indication to terminate camping on the first cell, a cell reselection procedure with a second cell.

2. The UE of claim 1, wherein the control information further indicates the threshold duration.

3. The UE of claim 1, wherein the processing system is further configured to cause the UE to:
obtain, from the first cell after the first time instance and before the second time instance, a second control message that resets or extends the threshold duration.

4. The UE of claim 1, wherein the processing system is further configured to cause the UE to:
obtain a broadcast transmission from the first cell that comprises the control message.

5. The UE of claim 1, wherein the processing system is further configured to cause the UE to:
obtain a transmission from the first cell that comprises an identifier associated with the UE.

6. The UE of claim 1, wherein the processing system is further configured to cause the UE to:
obtain second control information that indicates the first cell is operating in accordance with an energy saving configuration, wherein obtaining the indication to terminate camping on the first cell is based at least in part on the second control information.

7. The UE of claim 1, wherein the processing system is further configured to cause the UE to:
output, for the first cell while in the RRC connected state with the first cell and prior to the first time instance, a second control message that indicates a suggested threshold duration, wherein the threshold duration is based at least in part on the suggested threshold duration.

8. The UE of claim 1, wherein the processing system is further configured to cause the UE to:
output, after the first time instance and before the second time instance, a second control message that resets or extends the threshold duration or indicates that the UE will terminate camping on the first cell.

9. The UE of claim 8, wherein the processing system is further configured to cause the UE to:
obtain, from the first cell, an acknowledgment message in response to the second control message.

10. The UE of claim 8, wherein the processing system is further configured to cause the UE to:
transmit the second control message via a random access channel message, a scheduling request, an uplink wake up signal, or a small data transmission.

11. The UE of claim 1, wherein, to perform the cell reselection procedure, the processing system is configured to cause the UE to:
perform the cell reselection procedure in accordance with a first cell reselection configuration associated with camping on a cell associated with a first frequency range that is different from a second cell reselection configuration associated with camping on a cell of a second frequency range, wherein the second frequency range is lower than the first frequency range.

12. The UE of claim 1, wherein the processing system is further configured to cause the UE to:
monitor for, from the first cell after the first time instance and prior to the second time instance, paging messages, system information, synchronization signal blocks, or a combination thereof.

13. The UE of claim 12, wherein the processing system is further configured to cause the UE to:
obtain an indication of a signaling configuration associated with camping on the first cell, wherein the monitoring is based at least in part on the signaling configuration.

14. The UE of claim 1, wherein the processing system is further configured to cause the UE to:
obtain second control information that indicates one or more parameters associated with the cell reselection procedure, wherein the one or more parameters comprise a list of candidate cells, priorities associated with candidate cells, channel quality threshold information, or a combination thereof.

15. The UE of claim 1, wherein the processing system is further configured to cause the UE to:
output, for the first cell, an acknowledgment message in response to the control message.

16. The UE of claim 1, wherein the processing system is further configured to cause the UE to:
output, to the second cell, and indication of selection of the second cell in accordance with the cell reselection procedure.

17. The UE of claim 1, wherein performing the cell reselection procedure is based at least in part on an absence of a control signal from the first cell during the threshold duration, the control signal associated with resetting the threshold duration.

18. The UE of claim 1, wherein:
the RRC idle or inactive state is further associated with camping on a third cell of the set of cells, and
the indication at the second time instance further indicates to terminate camping on the third cell.

19. A method for wireless communications at a user equipment (UE), comprising:
obtaining, at a first time instance, control information that indicates to transition from a radio resource control (RRC) connected state with a set of cells to an RRC idle or inactive state associated with camping on a first cell of the set of cells;
obtaining, at a second time instance while in the RRC idle or inactive state, an indication to terminate camping on the first cell based at least in part on satisfaction of a threshold duration after the first time instance or receipt of a control message from the first cell; and
performing, based at least in part on the indication to terminate camping on the first cell, a cell reselection procedure with a second cell.

20. A non-transitory computer-readable medium storing code for wireless communications, the code comprising instructions executable by one or more processors to:
obtain, at a first time instance, control information that indicates to transition from a radio resource control (RRC) connected state with a set of cells to an RRC idle or inactive state associated with camping on a first cell of the set of cells;
obtain, at a second time instance while in the RRC idle or inactive state, an indication to terminate camping on the first cell based at least in part on satisfaction of a threshold duration after the first time instance or receipt of a control message from the first cell; and
perform, based at least in part on the indication to terminate camping on the first cell, a cell reselection procedure with a second cell.
